(19) United States
(12) Patent Application Publication
(10) Pub. No.: US 2009/0103705 A1
(43) Pub. Date: Apr. 23, 2009

(54) METHOD AND APPARATUS FOR ESTABLISHING AND FACILITATING AUDIO CONFERENCE OVER NETWORK

(75) Inventors: Jiong Liu, (US); Cheng-Jen Yang, Hukou Hsiang (TW)

Correspondence Address: Muncy, Geissler, Olds & Lowe, PLLC, P.O. BOX 1364, FAIRFAX, VA, 22038-1364, US

(73) Assignee: BROWAN COMMUNICATIONS, INC.

(21) Appl. No.: 12/037,607

(22) Filed: Feb. 26, 2008

(30) Foreign Application Priority Data
Oct. 23, 2007 (TW) 096139597

(51) Int. Cl. H04M 3/42

(52) U.S. Cl. 379/202.01

(57) ABSTRACT

The invention provides a method and apparatus for establishing and facilitating an audio conference over a network. The method transmits a notice information including a linking application to each of participant stations. Then, the method, based on the linking applications, links the participant stations and the chairman station to a site over the network to conduct the audio conference. Thereby, after receiving the notice information, the participants only have to execute the linking applications to automatically link to the site to participate in the audio conference as the audio conference begins.

### BACKGROUND OF THE INVENTION

1. Field of the Invention

The invention relates to a method and apparatus for establishing and facilitating an audio conference over a network, and more particularly, to a method and apparatus for linking, based on a linking application, the participant stations and the chairman station to the site over the network to conduct the audio conference.

2. Description of the Prior Art

At present time, audio conference is a widely used technology. It can link participants at different locations to the same site to exchange audio signals to achieve a multi-directional communication.

Conventionally, to start an audio conference, the conference manager (or the chairman) should login to the audio conference apparatus and send a request information representative of the request of establishing the audio conference for a plurality of participant stations. According to the request information, the audio conference apparatus transmits a notice information (e.g. e-mail) associated with the audio conference to each of the participants, where the notice information includes date, time, subject, list of the participants, and so on. As the conference begins, a participant should first enter the login page provided by the audio conference apparatus, and then login with the assigned account and password to the site for the audio conference, so as to link to the site to participate in the audio conference. For the participants, the procedure described above is usually too complicated and inconvenient.

In addition, during the audio conference, there are usually too many participants speaking at the same time, which causes the conference chaotic. Since current audio conference does not provide good management mechanism for the above mentioned problem, the bad situation remains still.

Accordingly, a scope of the invention is to provide a method and apparatus for establishing and facilitating an audio conference over a network to solve the above problem.

### SUMMARY OF THE INVENTION

A scope of the invention is to provide a method and apparatus for establishing and facilitating an audio conference over a network. The apparatus transmits a notice information with a linking application to each of the participant stations respectively, and, based on the linking applications, links the participant stations and the chairman station to the site over the network to conduct the audio conference. Thereby, the participants only have to execute the linking applications to automatically link to the site to participate in the audio conference. Since the participants do not need to install any other communication applications or to key in any accounts or passwords, it becomes very convenient for the participants.

According to an embodiment of the invention, the method is used for establishing and facilitating an audio conference. In the embodiment, the method, firstly, from a chairman station over the network, receives a request information representative of the request of establishing the audio conference for a plurality of participant stations. Then, the method allocates a site for the audio conference, and transmits over the network a notice information including a linking application associated with the site to each of the participant stations, respectively. After that, the method, based on the linking applications, links the participant stations and the chairman station to the site over the network to conduct the audio conference. Afterward, the method receives a control information from the chairman station over the network. Next, the method receives incoming audio signals from the chairman station and the participant stations over the network. Finally, the method, for each of the participant stations and the chairman station, mixes the incoming audio signals other than the incoming audio signal from the one station into a respective mixed audio signal in accordance with the control information, and transmits the mixed audio signal to the one station.

According to another embodiment of the invention, the apparatus is used for establishing and facilitating an audio conference over a network. The apparatus includes a communication module, an allocating module, a notification module, a linking module, a mixing module, and a bus.

The communication module is used for receiving, from a chairman station over the network, a request information representative of the request of establishing the audio conference for a plurality of participant stations.

The allocating module is used for allocating a site for the audio conference. The notification module is used for transmitting, through the communication module over the network, a notice information including a linking application associated with the site to each of the participant stations, respectively.

The linking module is used for linking, based on the linking applications, the participant stations and the chairman station to the site over the network to conduct the audio conference.

The mixing module can receive a control information from the chairman station through the communication module over the network, and receive incoming audio signals from the chairman station and the participant stations through the communication module over the network. Then, the mixing module can mix, for each of the participant stations and the chairman station, the incoming audio signals other than the incoming audio signal from the one station into a respective mixed audio signal in accordance with the control information. At last, the mixing module can transmit the mixed audio signal to the one station through the communication module over the network.

The bus is used for connecting the communication module, the allocating module, the notification module, the linking module, and the mixing module.

Therefore, the method and apparatus of the invention is for establishing and facilitating an audio conference over a network. The apparatus transmits a notice information with a linking application to each of the participant stations respectively, and, based on the linking application, links the participant stations and the chairman station to the site over the network to conduct the audio conference. Thereby, the participants only have to execute the linking application to automatically link to the site to participate the audio conference. Since the participants need not to install any other communication applications or to key in any accounts or passwords, it is very convenient for the participants to use. Besides, the chairman station can utilize a control information to manage the participants' rights to speak, so as to ensure that the conference will proceed orderly.

The advantage and spirit of the invention may be understood by the following recitations together with the appended drawings.

### BRIEF DESCRIPTION OF THE APPENDED DRAWINGS

FIG. 1 shows the functional block diagram of the audio conference apparatus according to an embodiment of the invention.

FIG. 2 shows the input interface provided by the audio conference apparatus shown in FIG. 1.

FIG. 3 shows the notice information transmitted by the notification module shown in FIG. 1.

FIG. 4 shows the management interface provided by the audio conference apparatus shown in FIG. 1.

FIG. 5 shows a flow chart of the method according to another embodiment of the invention.

### DETAILED DESCRIPTION OF THE INVENTION

The invention provides a method and apparatus for establishing and facilitating an audio conference over a network. The apparatus transmits a notice information with a linking application to each of the participant stations respectively, and, based on the linking application, links the participant stations and the chairman station to the site over the network to conduct the audio conference. Thereby, the participants only have to execute the linking application to automatically link to the site to participate in the audio conference. Since the participants do not need to install any other communication applications or to key in any accounts or passwords, it becomes very convenient for the participants. The spirit and feature of the present invention will be described in detail by the following embodiments.

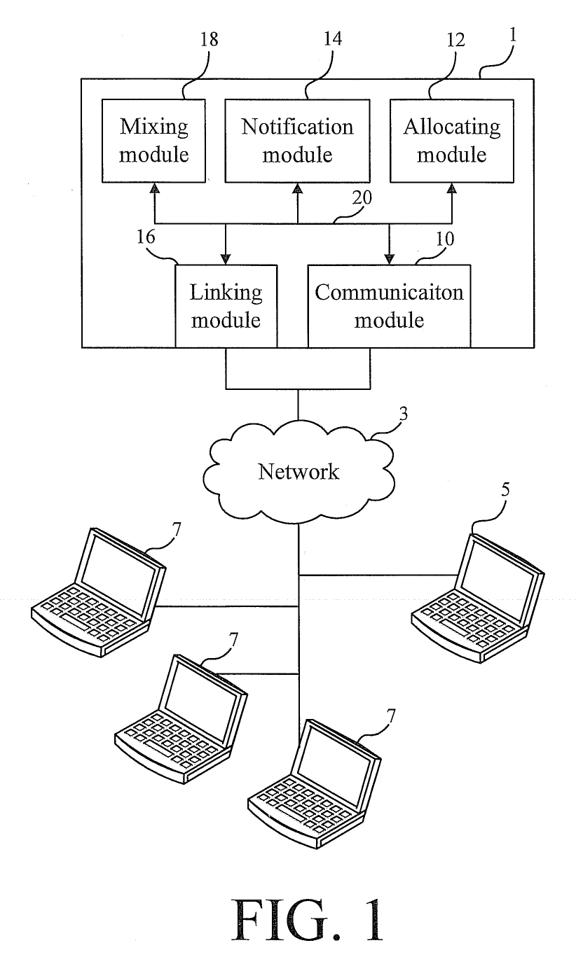

Please refer to FIG. 1. FIG. 1 shows the functional block diagram of the audio conference apparatus 1 according to an embodiment of the invention. In the embodiment, the audio conference apparatus 1 is used for establishing and facilitating an audio conference over a network 3. In actual applications, the network 3 can be an Internet, an Intranet, an Extranet, or the like.

As shown in FIG. 1, the audio conference apparatus 1 includes a communication module 10, an allocating module 12, a notification module 14, a linking module 16, a mixing module 18, and a bus 20. The bus 20 is used for connecting the communication module 10, the allocating module 12, the notification module 14, the linking module 16, and the mixing module 18.

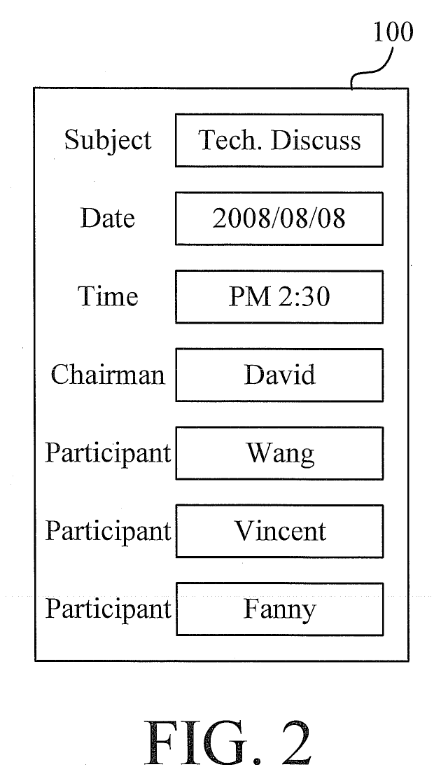

Please refer to FIG. 2. FIG. 2 shows the input interface 100 provided by the audio conference apparatus 1. In the embodiment, the communication module 10 can receive, from a chairman station 5 over the network 3, a request information representative of the request of establishing the audio conference for a plurality of participant stations 7. In practice, the request may include data associated with the audio conference, such as the date, time, subject, list of the participants, e-mail addresses of the participants, and so on. In practice, the participant of the chairman station 5 can use a particular account and password to login to the audio conference apparatus 1. After that, the audio conference apparatus 1 provides an input interface 100 as shown in FIG. 2 for the participant of the chairman station 5 to input the above data to generate the request information. Thereby, it is easy for communication module 10 to receive the request information.

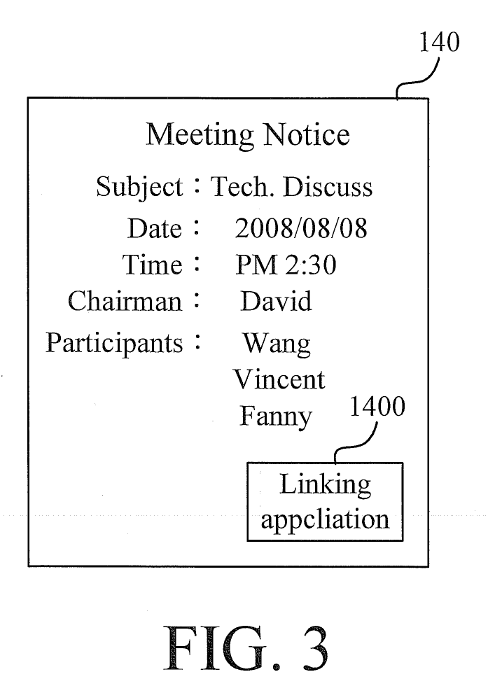

Please refer to FIG. 3. FIG. 3 shows the notice information 140 transmitted by the notification module 14 shown in FIG. 1. The allocating module 12 is used for allocating a site for the audio conference. The notification module 14 is used for transmitting, through the communication module 10 over the network 3, a notice information 140 including a linking application 1400 associated with the site to each of the participant stations 7, respectively. In practice, the notice information 140 may include data associated with the audio conference, such as the date, time, subject, list of the participants, and also includes the linking application 1400, as shown in FIG. 3. In actual applications, the notice information 140 can be transmitted in an SMTP (Simple Mail Transfer Protocol) standard, and can comply with, but not limited to, an MIME (Multipurpose Internet Mail Extensions) standard. In other words, the notice information 140 can be transmitted to the participant station 7 in an “e-mail” format. Besides, the linking application 1400 can preferably, but not limited to, be an ActiveX control application.

In the embodiment, when the audio conference begins, the linking module 16 can link, based on the linking applications 1400, the participant stations 7 and the chairman station 5 to the site over the network 3 to conduct the audio conference. In actual applications, during the audio conference time, the participant of the participant station 7 only needs to execute the linking application 1400 of the notice information 140, and the participant station 7 can automatically link, via the linking application 1400, to the linking module 16 of the audio conference apparatus 1.

Then, the linking module 16 can link, based on the linking applications 1400 of the participant stations 7, the participant stations 7 and the chairman station 5 to the site over the network 3 to conduct the audio conference. Thereby, the participants only have to execute the received linking applications 1400 to participate in the audio conference instead of doing complicated login procedure. Accordingly, it is very convenient for the participants.

The mixing module 18 can receive a control information from the chairman station 5 through the communication module 10 over the network 3, and receive incoming audio signals from the chairman station 5 and the participant stations 7 through the communication module 10 over the network 3 first. Then, the mixing module 18 can mix, for each of the participant stations 7 and the chairman station 5, the incoming audio signals other than the incoming audio signal from the one station into a respective mixed audio signal in accordance with the control information. At last, the mixing module 18 can transmit the mixed audio signal to the one station through the communication module 10 over the network 3.

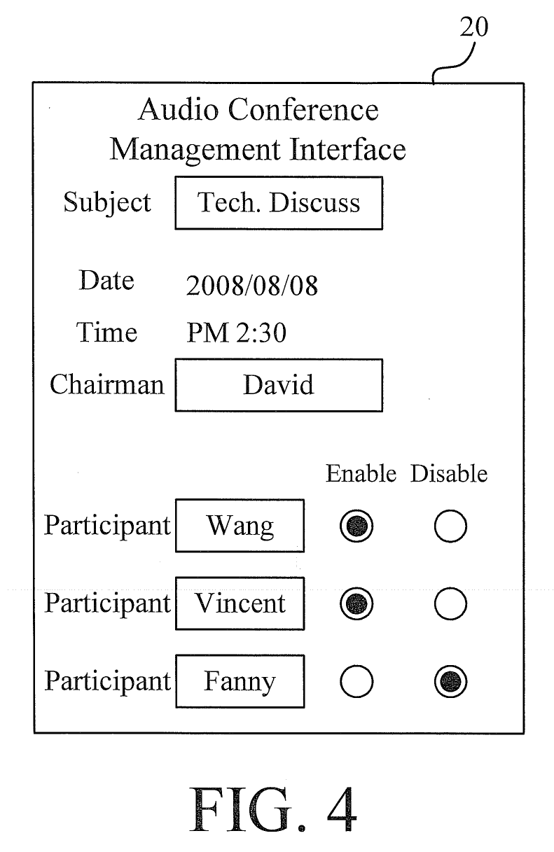

Please refer to FIG. 4. FIG. 4 shows the management interface 22 provided by the audio conference apparatus 1 shown in FIG. 1. In practice, the audio conference apparatus 1 can provide a management interface 22 as shown in FIG. 4 to the participant of the chairman station 5 for managing the audio conference. During the audio conference, the participant of the chairman station 5 can use the management interface 22 to decide each participant's right to speak, and generate the control information accordingly. The mixing module 18 can receive the control information and accordingly perform above mixing procedure. For example, when the chairman use the management interface 22 to mute the participant “Fanny”, for the participant station 7 of “Wang”, the mixing module 18 will only mix the incoming audio signals from the chairman station 5 of “David” and the participant station 7 of “Vincent” into a mixed audio signal in accordance with the control information, and transmit the mixed audio signal to the participant station 7 of “Wang” through the communication module 10 over the network 3. Accordingly, the participant “Wang” can only hear voices of “David” and “Vincent”, without the voice of “Fanny”. Thereby, the participant of the chairman station 5 can use the control information to manage the audio conference, so as to ensure that the conference will proceed orderly.

Therefore, after receiving the notice information, the participant only needs to execute the linking application to automatically link to the site to participate the audio conference as the audio conference begins. Since the participant does not need to install any other communication applications or to key in any account or password, it is very convenient for the participant.

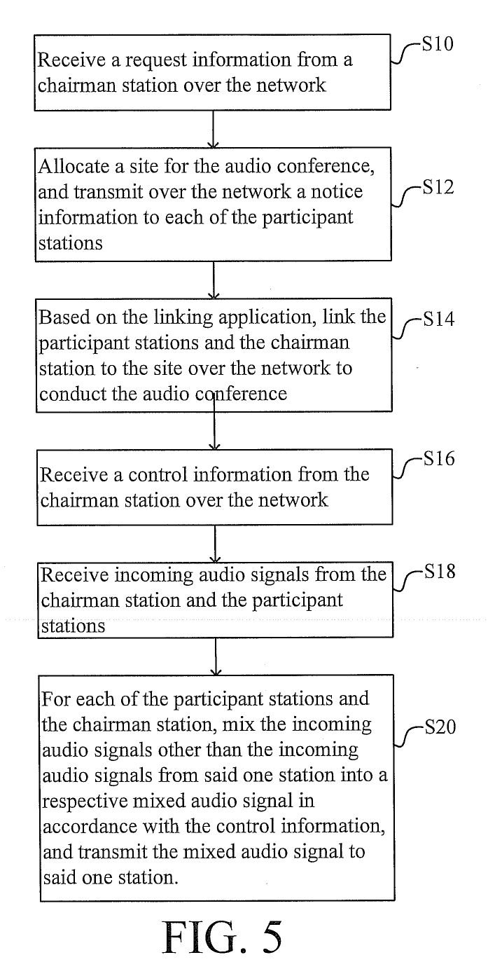

Please refer to FIG. 5 along with FIG. 1. FIG. 5 shows a flow chart of the method according to another embodiment of the invention. In the embodiment, the method is for establishing and facilitating an audio conference over a network 3. As shown in FIG. 5, the method, firstly, performs step S10 to, from a chairman station 5 over the network 3, receive a request information representative of the request of establishing the audio conference for a plurality of participant stations 7. In actual applications, the network 3 can be an Internet, an Intranet, an Extranet, or the like. Then, the method performs step S12 to allocate a site for the audio conference, and to transmit over the network 3 a notice information 140 including a linking application 1400 associated with the site to each of the participant stations 7, respectively. Afterward, the method performs step S14 to, based on the linking applications 1400, link the participant stations 7 and the chairman station 5 to the site over the network 3 to conduct the audio conference.

In actual applications, the notice information 140 can be transmitted in an SMTP (Simple Mail Transfer Protocol) standard, and can comply with an MIME (Multipurpose Internet Mail Extensions) standard. In other words, the notice information 140 can be transmitted to the participant station 7 in, but not limited to, an “e-mail” format. Besides, the linking application 1400 can preferably, but not limited to, be an ActiveX control application.

After that, the method performs step S16 to receive a control information from the chairman station 5 over the network 3. Next, the method performs step S18 to receive incoming audio signals from the chairman station 5 and the participant stations 7 over the network 3. Finally, the method performs step S20 to, for each of the participant stations 7 and the chairman station 5, mix the incoming audio signals other than the incoming audio signals from the one station into a respective mixed audio signal in accordance with the control information, and transmit the mixed audio signal to the one station.

Comparing with prior art, the method and apparatus of the invention is for establishing and facilitating an audio conference over a network. The apparatus transmits a notice information with a linking application to each of the participant stations respectively, and, based on the linking application, links the participant stations and the chairman station to the site over the network to conduct the audio conference. Thereby, the participants only have to execute the linking application to automatically link to the site to participate the audio conference. Since the participant need not to install any other communication applications or to key in any account or password, it is very convenient for the participants to use. Besides, the chairman station can utilize a control information to manage each participant's right to speak, so as to ensure that the conference will proceed orderly.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for establishing and facilitating an audio conference over a network, said method comprising the steps of:
from a chairman station over the network, receiving a request information representative of the request of establishing the audio conference for a plurality of participant stations;
allocating a site for the audio conference, and transmitting over the network a notice information comprising a linking application associated with the site to each of the participant stations, respectively;
based on the linking application, linking the participant stations and the chairman station to the site over the network to conduct the audio conference;
from the chairman station over the network, receiving a control information;
receiving incoming audio signals from the chairman station and the participant stations over the network; and
for each of the participant stations and the chairman station, mixing the incoming audio signals other than the incoming audio signal from said one station into a respective mixed audio signal in accordance with the control information, and transmitting the mixed audio signal to said one station.

2. The method of claim 1, wherein the notice information is transmitted in an SMTP (Simple Mail Transfer Protocol) standard.

3. The method of claim 1, wherein the format of the notice information complies with an MIME (Multipurpose Internet Mail Extensions) standard.

4. The method of claim 1, wherein the linking application is an ActiveX control application.

5. The method of claim 1, wherein the network is one selected from the group consisting of an Internet, an Intranet and an Extranet.

6. An apparatus for establishing and facilitating an audio conference over a network, comprising:
a communication module, for receiving, from a chairman station over the network, a request information representative of the request of establishing the audio conference for a plurality of participant stations;
an allocating module, for allocating a site for the audio conference;
a notification module, for transmitting, through the communication module over the network, a notice information comprising a linking application associated with the site to each of the participant stations, respectively;
a linking module, for linking, based on the linking applications, the participant stations and the chairman station to the site over the network to conduct the audio conference;
a mixing module, for receiving a control information from the chairman station through the communication module over the network, receiving incoming audio signals from the chairman station and the participant stations through the communication module over the network, mixing, for each of the participant stations and the chairman station, the incoming audio signals other than the incoming audio signal from said one station into a respective mixed audio signal in accordance with the control information, and transmitting the mixed audio signal to said one station through the communication module over the network; and
a bus, for connecting the communication module, the allocating module, the notification module, the linking module, and the mixing module.

7. The apparatus of claim 6, wherein the notice information is transmitted in an SMTP (Simple Mail Transfer Protocol) standard.

8. The apparatus of claim 6, wherein the format of the notice information complies with an MIME (Multipurpose Internet Mail Extensions) standard.

9. The apparatus of claim 6, wherein the linking application is an ActiveX control application.

10. The apparatus of claim 6, wherein the network is one selected from the group consisting of an Internet, an Intranet and an Extranet.
